(19) United States
(12) Patent Application Publication
(10) Pub. No.: US 2023/0102508 A1
(43) Pub. Date: Mar. 30, 2023

(54) Functional Housing Structure for an Electronic Device

(71) Applicants: Jyri KAIJA, Kista (SE); Huawei Technologies Co., Ltd., Shenzhen (CN)

(72) Inventors: Jyri Kaija, Helsinki (FI); Jouni Pennanen, Helsinki (FI); Mika Kolari, Helsinki (FI); Ngoc Huynh, Kista (SE)

(21) Appl. No.: 17/794,836

(22) PCT Filed: Jan. 24, 2020
(86) PCT No.: PCT/EP2020/051790

§ 371 Date: Jul. 22, 2022

(51) Int. Cl. H01Q 1/24; H04M 1/02

(52) U.S. Cl. CPC H01Q 1/241; H04M 1/0202

(57) ABSTRACT

A functional housing structure for an electronic device. The functional housing structure includes a first layer of dielectric material or meta material and an electronic circuitry arrangement. The electronic circuitry arrangement is at least partially embedded in the first layer, which is molded around the of the electronic circuitry arrangement.

### TECHNICAL FIELD

The disclosure relates to a functional housing structure for an electronic device.

### BACKGROUND

Future mobile electronic devices need to support an increasing number of components such as sensors, having various functionalities, and antennas, such as millimeter-wave antennas. However, the volume reserved for all additional components in a mobile electronic device is very limited, and the added components should ideally be accommodated in the same volume as existing components. Increasing the volume reserved for the additional components would make the electronic device larger, bulkier, and less attractive to users.

Furthermore, the movement towards very large displays, covering as much as possible of the electronic device, makes the space available for antennas very limited, forcing either the size of the antennas to be significantly reduced, and their performance impaired, or a large part of the display to be inactive.

Additionally, visible components as well as openings in the body of the mobile electronic devices are undesirable since they weaken the mechanical structure of the body, make manufacture and assembly more difficult, and makes the appearance of the device less attractive to users.

### SUMMARY

It is an object to provide an improved housing structure for an electronic device. The foregoing and other objects are achieved by the features of the independent claims. Further implementation forms are apparent from the dependent claims, the description, and the figures.

According to a first aspect, there is provided a functional housing structure for an electronic device, the housing structure comprising at least a first layer of dielectric or meta material and at least one electronic circuitry arrangement, at least part of the electronic circuitry arrangement being embedded in the first layer, by means of the first layer being molded around at least part of the electronic circuitry arrangement.

By integrating functional components into a non-conductive housing, the housing can meet a variety of design as well as functionality requirements. The functional component can be visible, or hidden adjacent the exterior surface of the housing such that it is invisible while it's function remains uninterrupted by the housing or other components. Furthermore, such a housing structure increases the locations available for placing an increasing number of functional components, without affecting the size of the housing structure.

In a possible implementation form of the first aspect, the functional housing structure further comprises a second layer of dielectric or meta material attached to the first layer of dielectric or meta material, at least part of the electronic circuitry arrangement being one of embedded in the second layer and arranged between the first layer and the second layer. This allows the layers of the housing structure as well as the parts of the electronic circuitry arrangement to be added separately and independently inside the first layer of dielectric or meta material.

In a further possible implementation form of the first aspect, the housing structure does not comprise any conductive layer or components other than the electronic circuitry arrangement, providing a housing wherein no other components affect the function of the electronic circuitry arrangement.

In a further possible implementation form of the first aspect, the electronic circuitry arrangement comprises a first component, the first component being embedded in the first layer and/or arranged between the first layer and the second layer.

In a further possible implementation form of the first aspect, the electronic circuitry arrangement further comprises at least a second component, the second component being attached to and/or at least partially embedded in the first layer and/or the second layer.

In a further possible implementation form of the first aspect, the electronic circuitry arrangement comprises a capacitive coupling, a galvanic coupling or a galvanic connection.

In a further possible implementation form of the first aspect, the first component is an antenna radiator, and the second component is an antenna feed, allowing antennas to be arranged in a variety of locations across the housing structure, facilitating antenna omnicoverage.

In a further possible implementation form of the first aspect, at least one of the first component and the second component is a sensor, allowing sensors to be arranged in a variety of locations across the housing structure.

In a further possible implementation form of the first aspect, the electronic circuitry arrangement comprises at least one of an antenna radiator, a parasitic antenna element, a reflector or director for mmWave antenna, a wavetrap for antenna, a transmission line, a power divider, RF balun, filter or diode, a soldering pad, a connector, an IC component, a PCB trace, a CPU, a GPU, a RAM, a switch, a feedline, a resonator, LED or other light source for illumination.

In a further possible implementation form of the first aspect, the second component extends through the second layer, such that the second component can be galvanically connected to additional components enclosed and carried by the housing structure.

In a further possible implementation form of the first aspect, the first layer comprises a first recess, the first component being at least partially arranged in the first recess.

In a further possible implementation form of the first aspect, the second layer comprises a second recess, the second component being at least partially arranged in the second recess.

In a further possible implementation form of the first aspect, the first component and/or the second component is attached to the first layer and/or the second layer by means of adhesive.

In a further possible implementation form of the first aspect, the first layer comprises glass and/or thermoplastic composite, facilitating an easily manufactured first layer which has a seamless outer surface.

In a further possible implementation form of the first aspect, the dielectric or meta material of the second layer is a foil laminated onto the first layer.

In a further possible implementation form of the first aspect, the housing structure comprises further layers of dielectric or meta material.

According to a second aspect, there is provided an electronic device comprising at least a display and a functional housing structure according to the above, wherein the display and the housing structure at least partially form an outer surface of the electronic device.

This and other aspects will be apparent from the embodiments described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 shows a partial cross-sectional view of a functional housing in accordance with one embodiment of the present invention;

FIG. 2 shows a partial cross-sectional view of a functional housing in accordance with one embodiment of the present invention;

FIG. 3 shows a partial cross-sectional view of a functional housing in accordance with one embodiment of the present invention;

FIG. 4 shows a partial cross-sectional view of a functional housing in accordance with one embodiment of the present invention.

### DETAILED DESCRIPTION

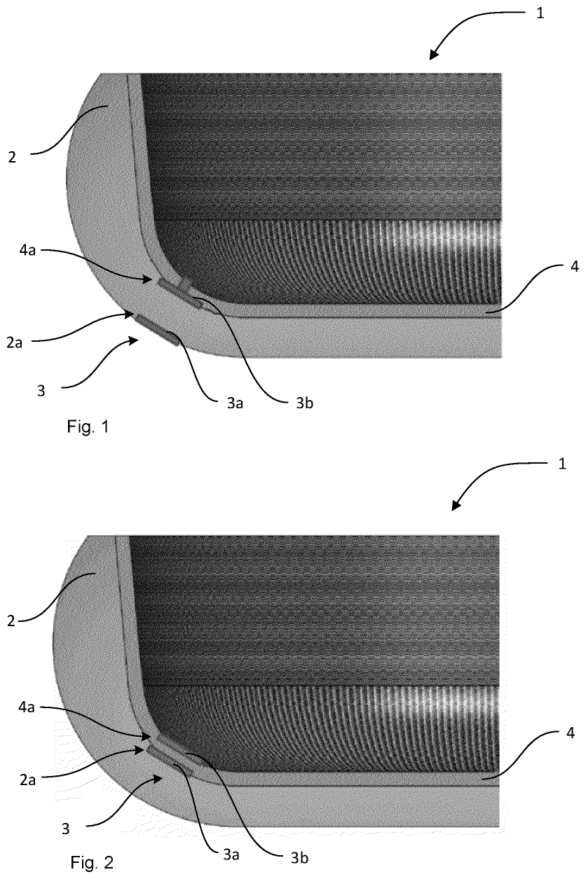

FIGS. 1 to 4 show embodiments of a functional housing structure 1 for an electronic device, such as a smartphone, tablet, or other mobile electronic device.

The housing structure 1 comprises at least a first layer 2 of dielectric or meta material and at least one electronic circuitry arrangement 3. At least part of the electronic circuitry arrangement 3 is embedded in the first layer 2, by means of the first layer 2 being molded around at least part of the electronic circuitry arrangement 3. In one embodiment, the housing structure 1 does not comprise any conductive layer or components other than the electronic circuitry arrangement 3.

The functional housing structure 1 may further comprise a second layer 4 of dielectric or meta material as shown in FIGS. 1, 2, and 4. The second layer 4 may be attached the first layer 2 of dielectric or meta material, as shown in FIGS. 1 and 2. Furthermore, the first layer 2 and the second layer 4 may be separated by e.g. an air gap, as shown in FIG. 4.

At least part of the electronic circuitry arrangement 3 may be embedded in the second layer 4, as shown in FIG. 4, or arranged between the first layer 2 and the second layer 4, as shown in FIGS. 1 and 2.

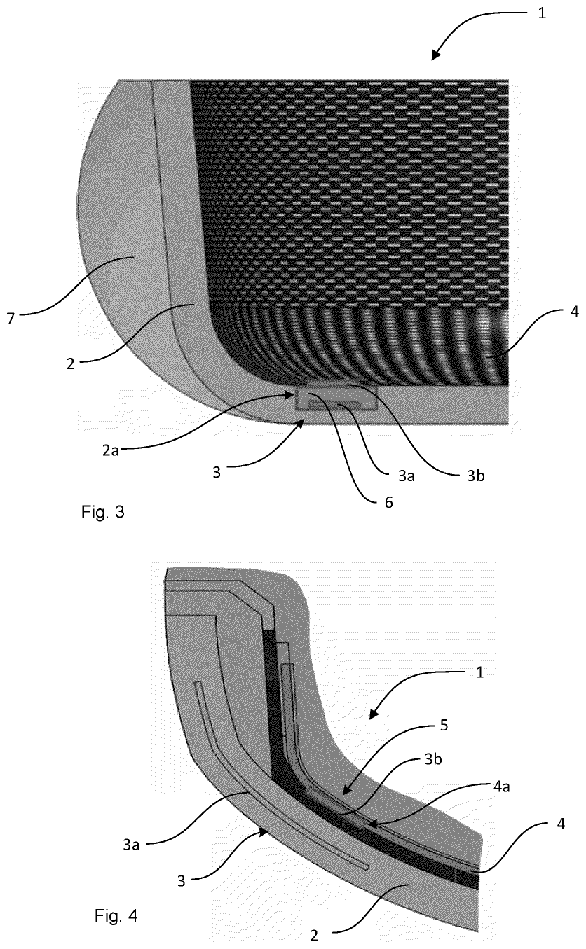

The functional housing structure 1 may comprise further layers 7 of dielectric or meta material, as shown in FIG. 3. One further layer 7, forming an exterior surface of the housing structure 1, may be a scratch-resistant coating.

The first layer 2, the second layer 4, and any further layers 7 may be laminated onto each other, or interconnected by means of adhesive. The layers may be pre-bent, thermoformed, or injection molded to a predetermined shape, preferably a three-dimensional shape as shown in the Figs.

The first layer 2 may comprise glass and/or thermoplastic composite, and may also be transparent or structural plastic. Furthermore, the dielectric or meta material of the second layer 4 may be a foil, e.g. a composite foil, laminated onto the first layer 2.

The electronic circuitry arrangement 3 may comprise a first component 3a which is embedded in the first layer 2 and/or arranged between the first layer 2 and the second layer 4. FIG. 1 shows an embodiment wherein the first component 3a is partially embedded into the first layer 2, adjacent an exterior surface of the housing structure 1. FIG. 2 shows an embodiment wherein the first component 3a is arranged between the first layer 2 and the second layer 4, and wherein the first component 3a may simultaneously be embedded into the first layer 2 and/or the second layer 4. FIG. 3 shows an embodiment wherein the first component 3a is embedded into the first layer 2, in a recess 2a extending from an interior surface of the first layer 2 and the housing structure 1. FIG. 4 shows an embodiment wherein the first component 3a is completely embedded into the first layer 2.

The electronic circuitry arrangement 3 may further comprise at least a second component 3b which is attached to and/or at least partially embedded in the first layer 2 and/or the second layer 4. FIG. 1 shows an embodiment wherein the second component 3b is arranged between the first layer 2 and the second layer 4 while simultaneously being partially embedded in the second layer 4. FIG. 2 shows an embodiment wherein the second component 3b is arranged adjacent an interior surface of the second layer 4, and wherein the second component 3b may simultaneously be embedded into the second layer 4. FIG. 3 shows an embodiment wherein the second component 3b is arranged adjacent an interior surface of the first layer 2. FIG. 4 shows an embodiment wherein the second component 3b is partially embedded in the second layer 4.

The electronic circuitry arrangement 3 may comprise further components (not shown), also arranged between the first layer 2 and the second layer 4, or at least partially embedded into the first layer 2 or the second layer 4.

The electronic circuitry arrangement 3 may furthermore comprise a capacitive coupling, a galvanic coupling or a galvanic connection 5.

The first component 3a and/or the second component 3b may be arranged such that they are invisible or visible to the user, the component forming a decorative element in case it is visible.

The first component 3a and/or the second component 3b may be discrete components attached to the first layer 2 and/or the second layer 4 by means of adhesive 6. The adhesive may fill up the first recess 2a, as shown in FIG. 3, and, optionally, simultaneously attach the second component 3b to the first layer 2.

The electronic circuitry arrangement 3 may comprise at least one of an antenna radiator, a parasitic antenna element, a reflector or director for mmWave antenna, a wavetrap for antenna, a transmission line, a power divider, RF balun, filter or diode, a soldering pad, a connector, an IC component, a PCB trace, a CPU, a GPU, a RAM, a switch, a feedline, a resonator, LED or other light source for illumination.

In one embodiment, the first component 3a is an antenna radiator, and the second component 3b is an antenna feed. Furthermore, at least one of the first component 3a and the second component 3b may be a sensor.

The first component 3a and/or the second component 3b may be wholly or partially overmolded by the first layer 2 and/or the second layer 4, respectively.

As shown in FIG. 1, the first component 3a may be partially embedded into the first layer 2, adjacent an exterior surface of the housing structure 1, or adhered to the exterior surface of the housing structure 1, such that the first component 3a is visible to the user. As mentioned above, the second component 3b may extend through the second layer 4 as shown in FIG. 1. The second component 3b may be an invisible capacitive antenna feed, e.g. a Shine antenna feed, and the first component 3a may be a visible and decorative capacitive antenna radiator.

As shown in FIG. 2, the first component 3a may be arranged between the first layer 2 and the second layer 4, the first component 3a being, e.g., an invisible capacitive antenna radiator. The second component 3b may be arranged adjacent an interior surface of the second layer 4, being an invisible capacitive antenna feed such as a Shine antenna feed.

The first layer 2 may also comprise a first recess 2a, as shown in FIG. 3, e.g. CNC machined into the first layer 2. The first component 3a is at least partially arranged within the first recess 2a. The first component 3a is interconnected to the first layer 2 and maintained within the first recess 2a by means of a dielectric material such as adhesive, or a thermoplastic composite. The second component 3b is connected to the very same dielectric material. The first component 3a may be a capacitive antenna radiator and the second component 3b may be a capacitive antenna feed.

The second layer 4 may be a thin foil or comprise a thicker layer of material. In the latter case, the second layer 4 may comprise a second recess 4a, as shown in FIG. 4, the second component 3b being at least partially arranged in the second recess 4a. The first component 3a may be an invisible capacitive antenna feed.

The present invention further relates to an electronic device comprising at least a display and a functional housing structure 1 according to the above. The display and the housing structure 1 at least partially form the outer surface of the electronic device.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1.-17. (canceled)

18. A functional housing structure for an electronic device, wherein the functional housing structure comprises:
a first layer of first dielectric material or first meta material, wherein the first layer comprises a glass composite; and
an electronic circuitry arrangement comprising a first part embedded in the first layer, wherein the first layer is molded around the first part.

19. The functional housing structure of claim 18, further comprising a second layer of second dielectric material or second meta material attached to the first layer, wherein a second part of the electronic circuitry arrangement is embedded in the second layer and arranged between the first layer and the second layer.

20. The functional housing structure of claim 19, wherein the second dielectric material or the second meta material comprises a foil laminated onto the first layer.

21. The functional housing structure of claim 19, wherein the electronic circuitry arrangement further comprises a first component, and wherein the first component is embedded in the first layer or arranged between the first layer and the second layer.

22. The functional housing structure of claim 21, wherein the electronic circuitry arrangement includes conductive material, and wherein all other portions of the functional housing structure are non-conductive.

23. The functional housing structure of claim 22, wherein the electronic circuitry arrangement further comprises a capacitive coupling, a galvanic coupling, or a galvanic connection.

24. The functional housing structure of claim 22, wherein the first layer comprises a first recess, and wherein the first component is partially arranged in the first recess.

25. The functional housing structure of claim 22, wherein the electronic circuitry arrangement further comprises a second component, wherein the second component is attached to or at least partially embedded in the first layer or the second layer.

26. The functional housing structure of claim 25, wherein the first component is an antenna radiator, and wherein the second component is an antenna feed.

27. The functional housing structure of claim 25, wherein at least one of the first component or the second component comprises a sensor.

28. The functional housing structure of claim 25, wherein the second component extends through the second layer.

29. The functional housing structure of claim 25, wherein the second layer comprises a second recess, and wherein the second component is partially arranged in the second recess.

30. The functional housing structure of claim 25, wherein the first component or the second component is attached to the first layer or the second layer by an adhesive.

31. The functional housing structure of claim 18, wherein the first layer further comprises a thermoplastic composite.

32. The functional housing structure of claim 18, wherein the electronic circuitry arrangement comprises at least one of an antenna radiator, a parasitic antenna element, a reflector or a director for a millimeter wave antenna, a wave trap for an antenna, a transmission line, a power divider, a radio frequency (RF) balun, a filter, a diode, a soldering pad, a connector, an integrated circuit (IC) component, a printed circuit board (PCB) trace, a central processing unit (CPU), a graphics processing unit (GPU), a random-access memory (RAM), a switch, a feedline, a resonator, or a light-emitting diode (LED) or other light source.

33. The functional housing structure of claim 18, further comprising a second layer of second dielectric material or second meta material.

34. An electronic device comprising:
a display; and
a functional housing structure coupled to the display and partially defining an outer surface of the electronic device, wherein the functional housing structure comprises:
a first layer of first dielectric material or first meta material, wherein the first layer comprises a glass composite; and
an electronic circuitry arrangement comprising a first part that is embedded in the first layer, wherein the first layer is molded around the first part.

35. The electronic device of claim 34, wherein the functional housing structure further comprises a second layer of second dielectric material or second meta material attached to the first layer, wherein a second part of the electronic circuitry arrangement is embedded in the second layer and arranged between the first layer and the second layer.

36. The electronic device of claim 35, wherein the electronic circuitry arrangement further comprises a first component, and wherein the first component is embedded in the first layer or arranged between the first layer and the second layer.

37. The electronic device of claim 36, wherein the electronic circuitry arrangement includes conductive material and all other portions of the functional housing structure are non-conductive.
